(19) United States
(12) Patent Application Publication
(10) Pub. No.: US 2025/0313657 A1
(43) Pub. Date: Oct. 9, 2025

(54) Furan Moiety-Containing Olefin Copolymer and Reversible Crosslinked or Functionalized Olefin Copolymer

(71) Applicant: ExxonMobil Technology and Engineering Company, Baytown, TX (US)

(72) Inventors: Yaxian Wang, Shanghai (CN); Yi Zhou, Shanghai (CN); Ke Ran Chen, Shanghai (CN); Yihan Cao, Shanghai (CN); Saifudin Bin Mohamed Abubakar, Singapore (SG); Lei Zhang, Basking Ridge, NJ (US); Wenxi Gao, Shanghai (CN)

(21) Appl. No.: 18/987,367

(22) Filed: Dec. 19, 2024

Related U.S. Application Data
(60) Provisional application No. 63/617,259, filed on Jan. 3, 2024.

(51) Int. Cl. C08F 210/02; C08F 232/08; C08J 3/24

(52) U.S. Cl. CPC C08F 210/02; C08F 232/08; C08J 3/24; C08F 2800/10; C08F 2810/20; C08J 2323/08; C08J 2345/00

(57) ABSTRACT

The present invention relates to a furan moiety-containing olefin copolymer and a process for preparing the same, and to a reversible crosslinked or functionalized olefin copolymer. The reversible crosslinked olefin copolymer as described therein performs as a thermoset material in use while still demonstrates the processability like traditional thermoplastics. The de-crosslinking process is triggered at higher temperature, which enables the material with good processability. While cooling down, crosslink would be further reformed and provides higher strength, better elasticity, resilience etc.

### CROSS-REFERENCE TO RELATED APPLICATION

This application claims priority to and the benefit of U.S. Provisional Application No. 63/617,259 having a filing date of Jan. 3, 2024, the disclosure of which is incorporated herein by reference in its entirety.

### FIELD OF THE INVENTION

The present invention relates to a furan moiety-containing olefin copolymer and a process for preparing the same, and to a reversible crosslinked or functionalized olefin copolymer.

### BACKGROUND OF THE INVENTION

Polyolefins are one of the most abundant, widely used, and rapidly developing varieties in polymer materials. The polar group functionalized polyolefins have significant improvement on properties, like compatibility, dyeability and adhesion. However, the poor tolerance of polar groups on transitional metal catalyst leads to the dominance of free-radical grafted polyolefin in the market. These kinds of grafted polyolefin suffer from inferior mechanical performance and shorter lifetime from radical driven degradation, and smelling problem from additive residuals.

In addition, the crosslinked olefin copolymer shows better stress creep resistance and chemical stability. However, conventional crosslink of polymer completely inhibits polymer melting and solubility, causing problem of polymer recovery and recycling. Thus, the crosslinked material is often directly buried or incinerated, which not only causes serious waste of resources but also results in environmental pollution.

Therefore, it is urgent to develop a polar group functionalized polyolefin with superior mechanical performances and a reversible crosslinked polyolefin resin providing both thermoset properties in use and thermoplastic properties in processing.

### SUMMARY OF THE INVENTION

In one aspect, embodiments of the invention provide a furan moiety-containing olefin copolymer comprising or consisting of the following monomers in copolymerized form:
A1) ethylene;
A2) a comonomer, which is selected from the group consisting of a functional α-olefin of Formula (I), a functional cyclic olefin of Formula (II) having a furan functional group, or a combination thereof,

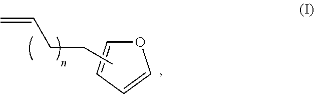

wherein the furyl ring in Formula (I) is optionally substituted with a halogen atom, or C₁-C₂₀ hydrocarbon group;
n is an integer in the range from 0 to 12;

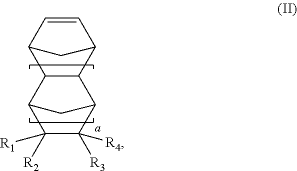

wherein R₁, R₂, R₃ and R₄ independently from each other represent a functional group containing furan moiety, a hydrogen atom, a halogen atom, or C₁-C₂₀ hydrocarbon group, wherein at least one of R₁ and R₂ represents a functional group containing furan moiety; or
two of R₁, R₂, R₃ and R₄ are bonded together to form a 3- to 7-membered saturated, or partially unsaturated or aromatic carbo- or heterocyclic ring containing at least one furan moiety, which may contain 1 to 4 heteroatoms selected from N, O and S;
a is an integer in the range from 0 to 5;
   and optionally
A3) a comonomer, which is selected from the group consisting of C₄-C₂₀ α-olefin, a cyclic olefin and acyclic C₄-C₃₀ diolefin.

In a further aspect, embodiments of the invention provide a process for preparing the furan moiety-containing olefin copolymer as described therein.

In a further aspect, embodiments of the invention provide use of the furan moiety-containing olefin copolymer as described therein as or in polymer compatibilizer, adhesive, barrier, composite, packaging, sealing, automobile or construction blocks.

In a further aspect, embodiments of the invention provide a reversible crosslinked or functionalized olefin copolymer prepared via Diels-Alder reaction of the furan moiety-containing olefin copolymer as described therein and organic connecting reagent.

The reversible crosslinked olefin copolymer as described therein performs as a thermoset material in use while still demonstrates the processability like traditional thermoplastics. The de-crosslinking process is triggered at higher temperature, which enables the material with good processability. While cooling down, crosslink would be further reformed and provides higher strength, better elasticity, resilience etc.

### DESCRIPTION OF PREFERRED EMBODIMENTS

Various specific embodiments, versions, and examples are as described herein; including exemplary embodiments and definitions that are adopted for purposes of understanding the claimed invention. While the following detailed description gives specific preferred embodiments, those skilled in the art will appreciate that these embodiments are exemplary only and that the invention can be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

All numerical values within the detailed description and the claims herein are modified by “about” the indicated value, and take into account experimental error and variations that would be expected by those skilled in the art.

In one aspect, embodiments of the invention provide a furan moiety-containing olefin copolymer comprising or consisting of the following monomers in copolymerized form:
A1) ethylene;
A2) a comonomer, which is selected from the group consisting of a functional α-olefin of Formula (I), a functional cyclic olefin of Formula (II) having a furan functional group, or a combination thereof,

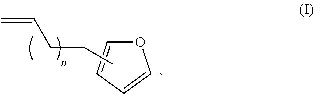

wherein the furyl ring in Formula (I) is optionally substituted with a halogen atom, or C₁-C₂₀ hydrocarbon group;
n is an integer in the range from 0 to 12;

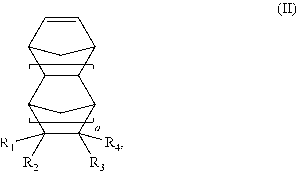

wherein R₁, R₂, R₃ and R₄ independently from each other represent a functional group containing furan moiety, a hydrogen atom, a halogen atom, or C₁-C₂₀ hydrocarbon group, wherein at least one of R₁ and R₂ represents a functional group containing furan moiety; or
two of R₁, R₂, R₃ and R₄ are bonded together to form a 3- to 7-membered saturated, or partially unsaturated or aromatic carbo- or heterocyclic ring containing at least one furan moiety, which may contain 1 to 4 heteroatoms selected from N, O and S;
a is an integer in the range from 0 to 5;
   and optionally
A3) a comonomer, which is selected from the group consisting of C₄-C₂₀ α-olefin, a cyclic olefin and acyclic C₄-C₃₀ diolefin.

In certain embodiments, in Formula (I), n is an integer in the range from 1 to 11, preferably from 2 to 10, more preferably from 3 to 9, most preferably from 3 to 8, particularly from 4 to 7, especially from 4 to 6.

In certain embodiments, the functional a-olefin of Formula (I) includes 2-furyl or 3-furyl, preferably 2-furyl.

In certain embodiments, in Formula (II), the functional group containing furan moiety represents a functional group R₅-Q, wherein R₅ represents a direct bond, divalent C₁-C₂₀ hydrocarbon group, or divalent C₂-C₂₀ hydrocarbon group interrupted by O, N, S, P, COO or CONH, and Q represents 2-furyl or 3-furyl.

In certain embodiments, in Formula (II), a is an integer in the range from 0 to 4, preferably from 0 to 3, more preferably from 0 to 2, most preferably 0 or 1, especially 0.

Examples of the halogen atoms include fluorine, chlorine, bromine and iodine.

Here, the hydrocarbon groups include an alkyl group, a cyclic saturated hydrocarbon group, a chain unsaturated hydrocarbon group and a cyclic unsaturated hydrocarbon group. The examples of the C₁-C₂₀ hydrocarbon groups include a C₁-C₂₀ alkyl, a C₃-C₂₀ cyclic saturated hydrocarbon group, a C₂-C₂₀ chain unsaturated hydrocarbon group and a C₃-C₂₀ cyclic unsaturated hydrocarbon group.

In certain embodiments, the examples of the C₁-C₂₀ alkyl groups include methyl, ethyl, n-propyl, n-butyl, n-pentyl, n-hexyl, n-heptyl, n-octyl, n-nonyl and n-decanyl that are straight-chain saturated hydrocarbon groups, and isopropyl, isobutyl, s-butyl, t-butyl, t-amyl, neopentyl, 3-methylpentyl, 1,1-diethylpropyl, 1,1-dimethylbutyl, 1-methyl-1-propylbutyl, 1,1-dipropylbutyl, 1,1-dimethyl-2-methylpropyl, 1-methyl-1-isopropyl-2-methylpropyl and cyclopropylmethyl that are branched saturated hydrocarbon groups. The number of carbon atoms of the alkyl group is preferably 2 to 16, more preferably 4 to 12, most preferably 4 to 8, especially 4 to 6.

In certain embodiments, the examples of the C₃-C₂₀ cyclic saturated hydrocarbon groups include cyclopropyl, cyclobutyl, cyclopentyl, cyclohexyl, cycloheptyl, cyclooctyl, 1-adamantyl and 2-adamantyl that are cyclic saturated hydrocarbon groups, and 3-methylcyclopentyl, 3-methylcyclohexyl, 4-methylcyclohexyl, 4-cyclohexylcyclohexyl and 4-phenylcyclohexyl that are cyclic saturated hydrocarbon groups wherein one hydrogen atom is substituted by a C₁-C₁₇ hydrocarbon group. The number of carbon atoms of the cyclic saturated hydrocarbon group is preferably 5 to 16, more preferably 5 to 12, most preferably 4 to 8, especially 5 to 6.

In certain embodiments, the examples of the C₂-C₂₀ chain unsaturated hydrocarbon groups include ethenyl (vinyl), 1-propenyl, 2-propenyl (allyl) and 1-methylethenyl (isopropenyl) that are alkenyl groups, and ethynyl, 1-propynyl and 2-propynyl (propargyl) that are alkynyl groups. The number of carbon atoms of the chain unsaturated hydrocarbon group is preferably 2 to 16, more preferably 4 to 12, most preferably 4 to 8, especially 4 to 6.

In certain embodiments, the examples of the C₃-C₂₀ cyclic unsaturated hydrocarbon groups include cyclopentadienyl, norbornyl, phenyl, naphthyl, indenyl, azulenyl, phenanthryl and anthracenyl that are cyclic unsaturated hydrocarbon groups, 3-methylphenyl (m-tolyl), 4-methylphenyl (p-tolyl), 4-ethylphenyl, 4-t-butylphenyl, 4-cyclohexylphenyl, biphenylyl, 3,4-dimethylphenyl, 3,5-dimethylphenyl and 2,4,6-trimethylphenyl (mesityl) that are cyclic unsaturated hydrocarbon groups wherein one hydrogen atom is substituted by a C₁-C15 hydrocarbon group, and benzyl and cumyl that are straight-chain saturated hydrocarbon groups or branched saturated hydrocarbon groups wherein one hydrogen atom is substituted by a C₃-C₁₉ cyclic unsaturated hydrocarbon group. The number of carbon atoms of the cyclic unsaturated hydrocarbon group is preferably 5 to 16, more preferably 5 to 12, most preferably 4 to 8, especially 4 to 6.

In certain embodiments, the examples of 3- to 7-membered saturated carbocyclic rings include cyclopropane, cyclobutane, cyclopentane, cyclohexane or cycloheptane rings.

In certain embodiments, the examples of 3- to 7-membered partially unsaturated carbocyclic rings include cyclopropene, cyclobutene, cyclopentene, cyclohexene, cycloheptene, cyclopentadiene, cyclohexadiene or cycloheptadiene rings.

In certain embodiments, the examples of 3- to 7-membered saturated, partially unsaturated or aromatic heterocyclic rings which may contain 1, 2, 3 or 4 heteroatoms include monocyclic radicals, the monocyclic radicals being saturated, partially unsaturated or aromatic (completely unsaturated). The heterocyclic radical may be attached to the remainder of the molecule via a carbon ring member or via a nitrogen ring member.

In certain embodiments, the examples of 3- to 7-membered saturated heterocyclic rings include oxiranyl, aziridinyl, azetidinyl, 2-tetrahydrofuranyl, 3-tetrahydrofuranyl, 2-tetrahydrothienyl, 3-tetrahydrothienyl, 2-pyrrolidinyl, 3-pyrrolidinyl, 3-pyrazolidinyl, 4-pyrazolidinyl, 5-pyrazolidinyl, 2-imidazolidinyl, 4-imidazolidinyl, 2-oxazolidinyl, 4-oxazolidinyl, 5-oxazolidinyl, 3-isoxazolidinyl, 4-isoxazolidinyl, 5-isoxazolidinyl, 2-thiazolidinyl, 4-thiazolidinyl, 5-thiazolidinyl, 3-isothiazolidinyl, 4-isothiazolidinyl, 5-isothiazolidinyl, 1,2,4-oxadiazolidin-3-yl, 1,2,4-oxadiazolidin-5-yl, 1,2,4-thiadiazolidin-3-yl, 1,2,4-thiadiazolidin-5-yl, 1,2,4-triazolidin-3-yl, 1,3,4-oxadiazolidin-2-yl, 1,3,4-thiadiazolidin-2-yl, 1,3,4-triazolidin-2-yl, 2-tetrahydropyranyl, 4-tetrahydropyranyl, 1,3-dioxan-5-yl, 1,4-dioxan-2-yl, 2-piperidinyl, 3-piperidinyl, 4-piperidinyl, 3-hexahydropyridazinyl, 4-hexahydropyridazinyl, 2-hexahydropyrimidinyl, 4-hexahydropyrimidinyl, 5-hexahydropyrimidinyl, 2-piperazinyl, 1,3,5-hexahydrotriazin-2-yl and 1, 2,4-hexahydrotriazin-3-yl, 2-morpholinyl, 3-morpholinyl, 2-thiomorpholinyl, 3-thiomorpholinyl, 1-oxothiomorpholin-2-yl, 1-oxothiomorpholin-3-yl, 1,1-dioxothiomorpholin-2-yl, 1,1-dioxothiomorpholin-3-yl, hexahydroazepin-1-, -2-, -3- or -4-yl, hexahydrooxepinyl, hexahydro-1,3-diazepinyl, hexahydro-1,4-diazepinyl, hexahydro-1,3-oxazepinyl, hexahydro-1,4-oxazepinyl, hexahydro-1,3-dioxepinyl, hexahydro-1,4-dioxepinyl and the like.

In certain embodiments, the examples of 3- to 7-membered partially unsaturated heterocyclic rings include 2,3-dihydrofur-2-yl, 2,3-dihydrofur-3-yl, 2,4-dihydrofur-2-yl, 2,4-dihydrofur-3-yl, 2,3-dihydrothien-2-yl, 2,3-dihydrothien-3-yl, 2,4-dihydrothien-2-yl, 2,4-dihydrothien-3-yl, 2-pyrrolin-2-yl, 2-pyrrolin-3-yl, 3-pyrrolin-2-yl, 3-pyrrolin-3-yl, 2-isoxazolin-3-yl, 3-isoxazolin-3-yl, 4-isoxazolin-3-yl, 2-isoxazolin-4-yl, 3-isoxazolin-4-yl, 4-isoxazolin-4-yl, 2-isoxazolin-5-yl, 3-isoxazolin-5-yl, 4-isoxazolin-5-yl, 2-isothiazolin-3-yl, 3-isothiazolin-3-yl, 4-isothiazolin-3-yl, 2-isothiazolin-4-yl, 3-isothiazolin-4-yl, 4-isothiazolin-4-yl, 2-isothiazolin-5-yl, 3-isothiazolin-5-yl, 4-isothiazolin-5-yl, 2,3 dihydropyrazol-1-yl, 2,3-dihydropyrazol-4-yl, 2,3-dihydropyrazol-2-yl, 2,3-dihydropyrazol-3-yl, 2,3-di¬hydropyrazol-5-yl, 3,4-dihydropyrazol-1-yl, 3,4-dihydropyrazol-3-yl, 3,4-dihydropyrazol-4-yl, 3,4-dihydropyrazol-5-yl, 4,5-dihydropyrazol-1-yl, 4,5-dihydropyrazol-3-yl, 4,5-di hydropyrazol-4-yl, 4,5-dihydropyrazol-5-yl, 2,3-dihydrooxazol-2-yl, 2,3-dihydrooxazol-3-yl, 2,3-dihydrooxazol-4-yl, 2,3-dihydrooxazol-5-yl, 3,4-dihydrooxazol-2-yl, 3,4-dihydro¬oxazol-3-yl, 3,4-dihydrooxazol-4-yl, 3,4-dihydrooxazol-5-yl, 3,4-dihydrooxazol-2-yl, 3,4-dihydrooxazol-3-yl, 3,4-dihydrooxazol-4-yl, 2-, 3-, 4-, 5- or 6-di- or tetrahydropyridinyl, 3-di- or tetrahydropyridazinyl, 4-di- or tetrahydropyridazinyl, 2-di- or tetrahydropyrimidinyl, 4-di- or tetrahydropyrimidinyl, 5-di- or tetrahydropyrimidinyl, di- or tetrahydropyrazinyl, 1,3,5-di- or tetrahydrotriazin-2-yl, 1,2,4-di- or tetrahydrotriazin-3-yl and the like.

In certain embodiments, the examples of 3- to 7-membered aromatic heterocyclic rings include 2-furyl, 3-furyl, 2-thienyl, 3-thienyl, 2-pyrrolyl, 3-pyrrolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 4-imidazolyl, 1,3,4-triazol-2-yl, 2-pyridinyl, 3-pyridinyl, 4-pyridinyl, 3-pyridazinyl, 4-pyridazinyl, 2-pyrimidinyl, 4-pyrimidinyl, 5-pyrimidinyl and 2-pyrazinyl and the like.

In certain embodiments, as the comonomer A3), the examples of C₄-C₂₀ α-olefins include 1-butene, 1-pentene, 1-hexene, 4-methyl-1-pentene, 1-heptene, 1-octene, 1-decene, 1-dodecene, 1-tetradecene, 1-hexadecane and 1-eicosene. These α-olefins may be used alone, or two or more types may be used in combination. Among these, C₄-C₈ α-olefins, especially 1-butene, 1-hexene, 1-octene are preferred. Particularly, 1-hexene is suitable.

In certain embodiments, as the comonomer A3), the examples of the cyclic olefin include aromatic group-containing monomers with up to 30 carbon atoms and non-aromatic cyclic group containing monomers with up to 30 carbon atoms.

Suitable aromatic group-containing monomers comprise at least one, preferably from one to three aromatic structure, more preferably a phenyl, indenyl, fluorenyl, or naphthyl moiety. The aromatic group-containing monomer further comprises at least one polymerizable double bond such that after polymerization, the aromatic structure will be pendant from the polymer backbone. The aromatic group-containing monomer may further be substituted with one or more hydrocarbyl groups including but not limited to C₁-C₁₀ alkyl groups. Additionally, two adjacent substituents may be joined to form a ring structure. Preferred aromatic group-containing monomers contain at least one aromatic structure appended to a polymerizable olefinic moiety. Particularly preferred aromatic group-containing monomers include styrene, α-methylstyrene, para-alkylstyrenes, vinyltoluenes, vinylnaphthalene, allyl benzene, and indene, especially styrene, paramethyl styrene, 4-phenyl-1-butene and allyl benzene.

Suitable non-aromatic cyclic group containing monomers preferably have at least one polymerizable olefinic group that is either pendant on the cyclic structure or is part of the cyclic structure. The cyclic structure may also be further substituted by one or more hydrocarbyl groups such as, but not limited to, C₁-C₁₀ alkyl groups. Preferred non-aromatic cyclic group containing monomers include norbornene and derivatives thereof, and mono-cyclic non-aromatic olefins with at least one polymerizable olefinic group in the cyclic structure.

In certain embodiments, the non-aromatic cyclic group containing monomers include compounds of Formula (III):

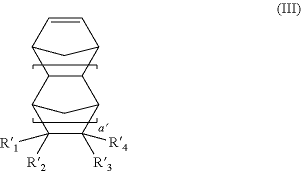

wherein R′₁, R′₂, R′₃ and R′₄ independently from each other represent a hydrogen atom, a halogen atom, or C₁-C₂₀ hydrocarbon group; or
two of R′₁, R′₂, R′₃ and R′₄ are bonded together to form a 3- to 7-membered saturated, or partially unsaturated or aromatic carbo- or heterocyclic ring, which may contain 1 to 4 heteroatoms selected from N, O and S;
   a′ is an integer in the range from 0 to 5.

In certain embodiments, in formula (III), a′ is an integer in the range from 0 to 4, preferably from 0 to 3, more preferably from 0 to 2, most preferably 0 or 1, especially 0.

In certain embodiments, the non-aromatic cyclic group containing monomers include cyclobutene, cyclopentene, cyclohexene, cyclooctene, vinyladamantane, cyclopentadiene, cyclooctadiene, norbornene, vinylnorbornene, norbornadiene, ethylidene norbornene, dicyclopentadiene or higher ring containing diolefins with or without substituents at various ring positions.

In certain preferred embodiments, the non-aromatic cyclic group containing monomers include:

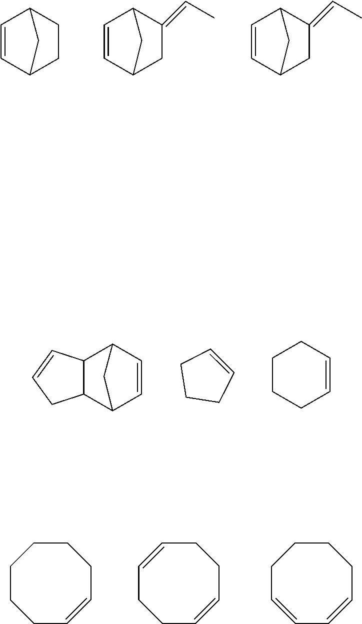

In certain embodiments, as the comonomer A3), the examples of acyclic C₄-C₃₀ diolefin monomers include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, preferably 1,6-heptadiene, 1,7-octadiene, 1,8-nonadiene, 1,9-decadiene, 1,10-undecadiene, 1,11-dodecadiene, 1,12-tridecadiene and 1,13-tetradecadiene.

In certain embodiments, the amount of unit derived from ethylene is in the range from 10 to 99.9 mol %, preferably from 12 to 98 mol %, more preferably from 15 to 96 mol %, most preferably from 20 to 95 mol %, for example from 20 to 25 mol %, or from 25 to 30 mol %, or from 30 to 35 mol %, or from 35 to 40 mol %, or from 40 to 45 mol %, or from 45 to 50 mol %, or from 50 to 55 mol %, or from 55 to 60 mol %, or from 60 to 65 mol %, or from 65 to 70 mol %, or from 70 to 75 mol %, or from 75 to 80 mol %, or from 80 to 85 mol %, or from 85 to 90 mol %, or from 90 to 95 mol %, based on the total molar amount of the monomeric units in the furan moiety-containing olefin copolymer of the present invention.

In certain embodiments, the amount of unit derived from the comonomer A2) is in the range from 0.01 to 30 mol %, preferably from 0.05 to 25 mol %, more preferably from 0.2 to 23 mol %, most preferably from 0.5 to 20 mol %, for example from 1 to 2.5 mol %, or from 2.5 to 5 mol %, or from 5 to 7.5 mol %, or from 7.5 to 10 mol %, or from 10 to 12.5 mol %, or from 12.5 to 15 mol %, or from 15 to 17.5 mol %, or from 17.5 to 20 mol %, based on the total molar amount of the monomeric units in the furan moiety-containing olefin copolymer of the present invention.

In certain embodiments, the amount of unit derived from the comonomer A3) is in the range from 0 to 85 mol %, preferably from 5 to 80 mol %, more preferably from 6 to 78 mol %, most preferably from 7 to 75 mol %, for example from 10 to 15 mol %, or from 15 to 20 mol %, or from 20 to 25 mol %, or from 25 to 30 mol %, or from 30 to 55 mol %, or from 35 to 40 mol %, or from 40 to 45 mol %, or from 45 to 50 mol %, or from 50 to 55 mol %, or from 55 to 60 mol %, or from 60 to 65 mol %, or from 65 to 70 mol %, or from 70 to 75 mol %, based on the total molar amount of the monomeric units in the furan moiety-containing olefin copolymer of the present invention.

The weight-average molecular weight (Mw) of the furan moiety-containing olefin copolymer of the present invention is in the range from 4 to 300 KDa, preferably from 5 to 280 KDa, more preferably from 6 to 250 KDa, for example from 10 to 20 KDa, or from 20 to 30 KDa, or from 30 to 40 KDa, or from 40 to 50 KDa, or from 50 to 60 KDa, or from 60 to 70 KDa, or from 70 to 80 KDa, or from 80 to 90 KDa, or from 90 to 100 KDa, or from 100 to 110 KDa, or from 110 to 120 KDa, or from 120 to 130 KDa, or from 130 to 140 KDa, or from 140 to 150 KDa, or from 150 to 160 KDa, or from 160 to 170 KDa, or from 170 to 180 KDa, or from 180 to 190 KDa, or from 190 to 200 KDa, or from 200 to 210 KDa, or from 210 to 220 KDa, or from 220 to 230 KDa, or from 230 to 240 KDa, or from 240 to 250 KDa, as determined by gel permeation chromatography (GPC). The polydispersity index (PDI) (M_{w}/Mₙ) of the furan moiety-containing olefin copolymer of the present invention is in the range from 1.2 to 8, preferably from 1.3 to 6.5, more preferably from 1.5 to 6.3, most preferably from 2 to 6, for example from 2 to 2.5, or from 2.5 to 3, or from 3 to 3.5, or from 3.5 to 4, or from 4 to 4.5, or from 4.5 to 5, or from 5 to 5.5, or from 5.5 to 6.

The glass transition temperature (Tg) of the furan moiety-containing olefin copolymer of the present invention is in the range from −70° C. to 100° C., or from −60° C. to 100° C., or from −50° C. to 100° C., or from 0° C. to 100° C., or from 30° C. to 100° C., or from 30° C. to 80° C., or from 30° C. to 60° C., or from 30° C. to 50° C., or from 30° C. to 40° C. The glass transition temperature can be measured by differential scanning calorimeter (DSC) by raising the temperature with a temperature ramp of 10° C./min from −100° C. to 250° C. Alternatively, the glass transition temperature can be measured by dynamic mechanical thermal analysis (DMTA). The testing was performed in torsion fixture at a frequency of 1 Hz in the temperature range from 35° C. to 350° C. with a heating rate of 5° C./min in N₂ atmosphere.

In a further aspect, embodiments of the invention provide a process for preparing the furan moiety-containing olefin copolymer as described therein by copolymerizing monomers A1), A2) and optionally A3).

In certain embodiments, the above process for preparing the furan moiety-containing olefin copolymer can be carried out with a precatalyst compound.

In certain embodiments, the precatalyst compounds useful herein are typically metallocenes, half metallocenes, and post-metallocene complexes such as those represented by the Formula (IV):

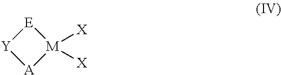

wherein;
M is a Group IIIB, IVB, VB, VIB or VIII transition metal atom, a Lanthanide metal atom, or an Actinide metal atom, preferably Titanium, Vanadium, Zirconium, Hafnium, Nickle or Palladium, more preferably Titanium, Vanadium, Zirconium or Hafnium, most preferably Titanium or Zirconium;
E is substituted or unsubstituted cyclopentadienyl ligand, substituted or unsubstituted indenyl ligand, or substituted or unsubstituted fluorenyl ligand;
A is substituted or unsubstituted indenyl ligand, a substituted or unsubstituted cyclopentadienyl ligand, a substituted or unsubstituted fluorenyl ligand or —NR, wherein R represent a hydrogen atom, a halogen atom, or C₁-C₂₀ hydrocarbon group, preferably C₁-C₂₀ alkyl group, more preferably C₂-C₁₂ alkyl group, most preferably C₄-C₈ alkyl group, especially C₄-C₆ alkyl group;
Y is a bridging group comprising C, Si or Ge, preferably C or Si, for example a C₁-C₁₂ alkylene, preferably C₁-C₈ alkylene, more preferably C₁-C₄ alkylene, most preferably C₁-C₂ alkylene, for example CH₂, CH₂CH₂, CH(CH₃), CH₂CH₂CH₂, CH(CH₃)CH₂, CH₂CH(CH₃), CH₂CH₂CH₂CH₂, CH₂CH₂CH₂CH₂CH₂, CH₂CH₂CH₂CH₂CH₂CH₂, and CH₂CH₂CH₂CH₂CH₂CH₂CH₂, wherein these bridging groups are unsubstituted or substituted with at least one, preferably two substituents selected from the group consisting of halogen, C₁-C₆ alkyl group or phenyl, preferably C₁-C₄ alkyl group or phenyl, more preferably methyl or phenyl; preferably Y is selected from the group consisting of CH₂, CPh₂, CH₂CH₂, C(CH₃)₂, SiMe₂, SiPh₂ or SiMePh; and
each X is, independently, a univalent anionic ligand, preferably halide ion, more preferably Cl⁻, or both X are joined and bound to the metal atom to form a metallocycle ring, or both X are joined to form a chelating ligand, a diene ligand, or an alkylidene ligand.

In certain embodiments, the precatalyst compounds are rac-[En(Ind)₂]ZrCl₂, [Me₂Si(C₅Me₄)(N^{t}Bu)]TiCl₂ or [Ph₂C(Flu)(Cp)]ZrCl₂.

The precatalyst compounds described herein can be commercially available or prepared as known in the art.

The precatalyst compounds described herein are combined with an activator(s) to form a catalyst system used in the polymerization processes described herein.

The terms “cocatalyst” and “activator” are used herein interchangeably and arc defined to be any compound which can activate any one of the precatalyst compounds described above by converting the neutral precatalyst compound to a catalytically active catalyst compound cation. Non-limiting activators, for example, include alumoxanes, aluminum alkyls, ionizing activators, which may be neutral or ionic, and conventional cocatalysts. Preferred activators typically include alumoxane compounds, modified alumoxane compounds, and ionizing anion precursor compounds that abstract a reactive, o-bound, metal ligand making the metal complex cationic and providing a charge-balancing noncoordinating or weakly coordinating anion.

In one embodiment, alumoxane activators are utilized as an activator in the catalyst system. Alumoxanes are generally oligomeric compounds containing —Al(R″)—O-subunits, where R″ is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as precatalyst activators, particularly when the abstractable ligand is an alkyl, halide, alkoxide or amide. Mixtures of different alumoxanes and modified alumoxanes may also be used. It may be preferable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

When the activator is an alumoxane (modified or unmodified), certain embodiments select the maximum amount of activator at a 10000-fold molar excess Al/M over the precatalyst compound (per metal catalytic site). The minimum activator-to-precatalyst-compound is a 1:1 molar ratio. Alternative preferred ranges include from 100:1 to 8000:1, or from 500:1 to 6000:1, or from 1000:1 to 5000:1, or from 2000:1 to 4000:1.

In certain embodiments, little or no alumoxane is used in the polymerization processes described herein. In certain embodiments, the alumoxane is present at a molar ratio of aluminum to transition metal of less than 500:1, preferably less than 300:1, preferably less than 100:1, preferably less than 1:1.

The polymerization processes of the present invention can be carried out in any manner known in the art. Any homogeneous, bulk, supercritical, or solution phase polymerization process known in the art can be used. Such processes can be run in a batch, semi-batch or continuous mode. A homogeneous polymerization process is preferred. A homogeneous polymerization process is defined to be a process where at least 90 wt % of the product is soluble in the reaction media. A bulk homogeneous process is particularly preferred. A bulk homogeneous process is defined to be a process where monomer concentration in all feeds to the reactor is 70 volume % or more. Alternatively, no solvent or diluent is present or added in the reaction medium, except for the small amounts used as the carrier for the catalyst system or other additives or amounts typically found with the monomer.

Suitable diluents/solvents for polymerization include non-coordinating inert liquids. Examples include straight and branched-chain hydrocarbons, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar™); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexane, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is aromatic, preferably aromatics such as toluene are present in the solvent in an amount of more than 90 wt %, preferably more than 95 wt %, more preferably more than 98 wt %, most preferably more than 99.5 wt %, based on the total weight of the solvents.

Preferred polymerizations can be run at any temperature and/or pressure suitable to obtain the desired polymers. Typical temperatures and/or pressures include a temperature in the range of from about 25° C. to about 200° C., preferably about 25° C. to about 150° C., preferably about 30° C. to about 100° C.; and at a pressure in the range of greater than 0.05 MPa to about 30 MPa, preferably from about 0.08 MPa to about 20MPa, more preferably from about 0.09 MPa to about 15 MPa, most preferably from about 0.1 MPa to about 10 MPa.

In a typical polymerization, the run time of the reaction is up to 300 minutes, preferably in the range of from about 5 minutes to 250 minutes, more preferably from about 10 minutes to 120 minutes, most preferably from about 20 minutes to 80 minutes.

In certain embodiments of the process of the present invention, the furan moiety-containing olefin copolymer can undergo separation.

After the polymerization, the polymerization by-products thereof can be removed by a known process, including a filtration or a process using an adsorbent for adsorptive removal.

After the removal of the by-products thereof, the obtained furan moiety-containing olefin copolymer can be precipitated and then be collected by filtration, washed and dried.

In a further aspect, embodiments of the invention provide use of the furan moiety-containing olefin copolymer as described therein as or in polymer compatibilizer, adhesive, barrier, composite, packaging, sealing, automobile or construction blocks.

In a further aspect, embodiments of the invention provide a reversible crosslinked or functionalized olefin copolymer prepared via Diels-Alder reaction of the furan moiety-containing olefin copolymer as described therein and organic connecting reagent.

In certain embodiments, the organic connecting reagent is a compound of Formula (V):

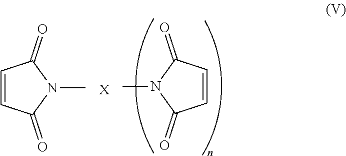

wherein X is a monovalent hydrocarbon group or multivalent hydrocarbyl linker group, and
n is O or an integer of at least 1.

In certain embodiments, the term “a monovalent hydrocarbon group” in the above formula refers to a hydrocarbyl, wherein the valency is derived by abstraction of a hydrogen from a carbon atom. Here, hydrocarbyl includes, for example, aliphatics (straight and branched chain), cycloaliphatics, aromatics and mixed character groups (e.g., aralkyl, alkylaryl, cycloalkynyl). More specifically, hydrocarbyl includes (but is not limited to) such groups as alkyl, cycloalkyl, aryl, aralkyl, alkylaryl, alkenyl and cycloalkenyl having from 1 to 50, preferably from 2 to 36, more preferably from 4 to 24, most preferably from 6 to 18 carbon atoms, and optionally at least one carbonyl group, carboxyl group, amide group, carbamate group, urea group, ester group, ether group, and combinations thereof, and/or at least one heteroatom (such as oxygen, sulfur, nitrogen or silicon) in the chain or ring.

In certain embodiments, the term “multivalent hydrocarbyl linker group” refers to a hydrocarbyl, as defined above, wherein the valencies are derived by the abstraction of at least two hydrogen from at least one carbon atom.

In certain embodiments, n is an integer of at least 2, preferably at least 5, more preferably at least 10, most preferably at least 15. In certain embodiments, n is an integer of at most 50, preferably at most 40, more preferably at most 30, most preferably at most 20.

Preferably, the organic connecting reagent is a bismaleimide of formula:

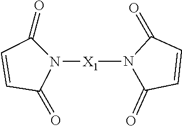

wherein X₁ is a divalent hydrocarbyl linker group.

Exemplary divalent hydrocarbyl linker groups can be selected from the group consisting of linear or branched alkylenes, cycloalkylenes, bicycloalkylenes, tricycloalkylenes, alkenylenes, arylenes, aralkylenes, arylbicycloalkylenes, aryltricycloalkylenes, cycloalkenylene, cycloalkylarylenes, biphenylenes, heterocycloalkylene or heteroarylenes having from 1 to 50, preferably from 2 to 36, more preferably from 4 to 24, most preferably from 6 to 18 carbon atoms, and optionally contain at least one carbonyl group, carboxyl group, amide group, carbamate group, urea group, ester group, ether group, and combinations thereof.

In certain embodiments, the organic connecting reagent is a multi-armed, such as three-, four-, five-, six-, seven- or eight-armed, or more-armed molecule with maleimide (MA) functional groups.

In certain embodiments, the organic connecting reagent can be obtained by reacting one or more bismaleimide compound of formula above with a polyfunctional linker. In certain embodiments, the linker includes polyfunctional alcohols or polyfunctional amines, which can connect with maleimide group to form a complex organic connecting reagent. The reaction of one or more bismaleimide compound of formula above with a multifunctional linker can be carried out in a known manner in the art.

In the sense of the invention, the term polyfunctional alcohol means alcohols that comprise at least two hydroxyl groups. Suitable polyfunctional alcohols exhibit two or more than two (e.g., 3, 4, 5, 6, and the like) hydroxyl groups. In this connection, the hydroxyl groups can also be partially or completely replaced by mercapto groups.

Examples for polyfunctional alcohols are diols, triols, polyols of higher valency, and relatively high molecular weight polyols.

Suitable diols are straight-chain and branched aliphatic and cycloaliphatic alcohols with generally approximately 2 to 30, preferably approximately 2 to 20 carbon atoms. These include 1,2-ethanediol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,5-hexanediol, 1,2-heptanediol, 1,7-heptanediol, 1,2-octanediol, 1,8-octanediol, 1,2-nonanediol, 1,9-nonanediol, 1,2-decanediol, 1,10-decanediol, 1,12-dodecanediol, 2-methyl-1,3-propanediol, 2-methyl-2-butyl-1,3-propanediol, 2,2-dimethyl-1,3-propanediol, 2,2-dimethyl-1,4-butanediol, pinacol, 2-ethyl-2-butyl-1,3-propanediol, diethylene glycol, triethylene glycol, dipropylene glycol, tripropylene glycol, polyalkylene glycols, cyclopentanediols, cyclohexanediols, and the like.

Suitable triols are, e.g., glycerol, butane-1,2,4-triol, n-pentane-1,2,5-triol, n-pentane-1,3,5-triol, n-hexane-1,2,6-triol, n-hexane-1,2,5-triol, trimethylolpropane and trimethylolbutane. Suitable triols are furthermore the triesters of hydroxycarboxylic acids with trivalent alcohols. Preferably, in this connection, they are triglycerides of hydroxycarboxylic acids, such as, e.g., lactic acid, hydroxystearic acid and ricinoleic acid. Naturally occurring mixtures comprising hydroxycarboxylic acid triglycerides, in particular castor oil, are also suitable.

Suitable polyols of higher valency are, e.g., sugar alcohols and their derivatives, such as erythritol, pentaerythritol, dipentaerythritol, threitol, inositol and sorbitol. Reaction products of the polyols with alkylene oxides, such as ethylene oxide and/or propylene oxide, are also suitable.

Relatively high molecular weight polyols with a number-average molecular weight in the range of approximately 400 to 6000 g/mol, preferably 500 to 4000 g/mol, can also be used. These include, e.g., polyesterols based on aliphatic, cycloaliphatic and/or aromatic di-, tri- and/or polycarboxylic acids with di-, tri- and/or polyols, and also the polyesterols based on lactone. These furthermore include polyetherols which can be obtained, e.g., by polymerization of cyclic ethers or by reaction of alkylene oxides with an initiator molecule. These furthermore also include conventional polycarbonates with terminal hydroxyl groups known to a person skilled in the art which can be obtained by reaction of the diols described above or also bisphenols, such as bisphenol A, with phosgene or carbonic diesters. α,ω-polyamidols, poly(methyl (meth)acrylate) α,ω-diols and/or poly(butyl (meth)acrylate) α,ω-diols, such as, e.g., MD-1000 and BD-1000 from Goldschmidt, are also suitable.

In the sense of the invention, the term polyfunctional amine means amines that comprise at least two amino groups. The polyfunctional amine is preferably selected from diamines or polymeric polyamines.

Suitable diamines are, for example, 1,2-ethylenediamine, 1,3-propylenediamine, 1,4-diaminobutane, 1,5-diaminopentane (cadaverine), 1,6-diaminohexane, 1,3-diamino-1-methylpropane, 1,4-diaminocyclohexane, piperazin, N-ethylethylenediamine, N,N′-diethylethylenediamine and mixtures thereof.

Suitable polymeric polyamines are in principle linear or branched polymers that have at least two primary or secondary amino groups. Additionally, these polymers can have tertiary amino groups in the polymer chain.

Preference is given to polymeric polyamines having a weight-average molecular weight of at least 300 g/mol. More preferred are polymeric polyamines having a weight-average molecular weight of from 350 to 3000, in particular from 375 to 2500, especially from 400 to 2000, more especially from 500 to 1500. Furthermore, polymeric polyamines typically have at least 3, preferably 4, in particular 5 repeating units.

The polymeric polyamine is preferably selected from polyaminosaccharides, polyamidoamines, polyesteramines, polyetheramines, polyamino acids, polyethyleneimines, and combinations thereof.

Preferred polyaminosaccharides are sugar molecule wherein a hydroxyl group has been replaced with an amine group. Preferred are chitosan composed of randomly distributed β-(1-4)-linked D-glucosamine (deacetylated unit) and N-acetyl-D-glucosamine (acetylated unit).

Preferred polyamidoamines are dendrimer which is made of repetitively branched subunits of amide and amine functionality. Preferred polyamidoamines are polylysine, which is homopolymers from lysine. It is prepared from amino acid lysine, which contains two amino groups, one at the α-carbon and one at the ε-carbon. Either can be the location of polymerization, resulting in α-polylysine or ε-polylysine. Preference is given to polylysine which have a average molecular weight from of 300 to 4000 g/mol, preferably from 400 to 3000 g/mol, more preferably, 500 to 1500 g/mol. Furthermore, polylysine according to the invention has at least 3, preferably 4, in particular 5 repeating units.

Preferred polyesteramines are in the context of the present invention, very generally polymeric compounds exhibiting ester groups and amino groups in the chain, amino groups not being part of an amide group. In principle, at least divalent compounds exhibiting one amino group, preferably no longer available for a subsequent reaction, and at least two additional functional groups, capable of an addition or condensation reaction, can be used. These include, for example, N-alkyl-N-(hydroxyalkyl)aminoalkanecarboxylic acids and carboxylic acid derivatives, N,N-di(hydroxyalkyl)aminoalkanecarboxylic acids and carboxylic acid derivatives, N-alkyl-N-(aminoalkyl)aminoalkanecarboxylic acids and carboxylic acid derivatives, N,N-di(aminoalkyl)aminoalkanecarboxylic acids and carboxylic acid derivatives, and the like. In addition to these monomers, the polyesteramines used according to the invention can comprise additional polyfunctional compounds incorporated exhibiting two or more than two (e.g., 3, 4, 5, 6, and the like) functional groups.

Preferred polyetheramines are the reaction products of at least one polyol with at least one C₂-C₁₈ alkylene oxide, to form an alkoxylated polyol and aminating the alkoxylated polyol with ammonia.

Preferred polyamino acids usually consist of repeating units of amino acids, wherein the homopolyamino acid is made from a single amino acid as a repeating unit, and the co-polyamino acid is a polymer made from at least two or more different amino acids as repeating units. Polyamino acids contain both an amino and a carboxylic acid functional group. Preferred polyamino acids are selected from the group consisting of poly-D,L-ornithine, poly-D,L-homoarginine, poly-D,L-arginine, poly-D,L-glutamic acid and poly-D,L-aspartic acid.

Preferred polyethyleneimines are diethylenetriamine, triethylenetetramine, tetraethylenepentamine, ethylenepropylenetriamine, trisaminopropylamine and higher polyethyleneimines, wherein polyethyleneimines may have a number-average molecular weight of at least 300 g/mol, preferably from 400 to 3000 or 450 to 2500 g/mol and in particular from 450 to 2000 g/mol.

“Alkylene” as defined herein refers to any divalent radical derived by the removal of two hydrogen atoms from an aliphatic saturated hydrocarbon.

“Cycloalkylene” as defined herein refers to any divalent radical derived by removal of two hydrogen atoms from cycloalkane.

“Bicycloalkylene” as defined herein refers to any divalent radical derived by removal of two hydrogen atoms from cycloalkane whose molecule contains two rings.

“Tricycloalkylene” as defined herein refers to any divalent radical derived by removal of two hydrogen atoms from cycloalkane whose molecule contains three rings.

“Alkenylene” as defined herein refers to any divalent radical derived by removal of two hydrogen atoms from different carbon atoms of an alkene.

“Arylene” as defined herein refers to any divalent radical derived by the removal of two hydrogen atoms from a polyunsaturated, aromatic single ring or multiple rings (preferably from 1 to 3 rings) which are fused together or linked covalently.

“Aralkylene” as defined herein refers to any divalent radical derived from an aryl group attached to the alkylene defined above.

“Arylbicycloalkylene” as defined herein refers to any divalent radical derived by removal of two hydrogen atoms from cycloalkane whose molecule contains two rings and an aryl group.

“Aryltricycloalkylene” as defined herein refers to any divalent radical derived by removal of two hydrogen atoms from cycloalkane whose molecule contains three rings and an aryl group.

“Cycloalkenylene” as defined herein refers to any divalent radical derived by removal of two hydrogen atoms from different carbon atoms of a cycloalkene.

“Cycloalkylarylenes” as defined herein refers to any divalent radical derived by removal of two hydrogen atoms from the aryl group comprised in a fused cycloalkylaryl containing both saturated ring and benzene rings.

“Biphenylene” as defined herein refers to any divalent radical derived by removal of two hydrogen atoms from polycyclic hydrocarbon composed of two benzene rings joined together by a pair of mutual attachments.

“Heterocycloalkylene” as defined herein refers to any divalent radical derived by removal of two hydrogen atoms from a non-aromatic monocyclic or polycyclic ring comprising carbon and hydrogen atoms and at least one heteroatom, preferably, 1 to 4 heteroatoms selected from N, O and S.

“Heteroarylene” as defined herein refers to any divalent radical derived by removal of two hydrogen atoms from an aromatic group containing polycyclic ring comprising carbon and hydrogen atoms and at least one heteroatom, preferably, 1 to 4 heteroatoms selected from N, O and S.

In certain embodiments, the divalent hydrocarbyl linker group can be interrupted by at least one of O, N, S, P, COO or CONH.

In certain embodiments, the divalent hydrocarbyl linker group and maleimide ring are optionally substituted with a halogen atom, or C₁-C₂₀ hydrocarbon group.

The reversible attribution of reversible crosslinked or functionalized olefin copolymer can be triggered by Diels-Alder reaction, wherein the reversible crosslinked olefin copolymer can be obtained from the above compound of Formula (V) wherein X is a multivalent hydrocarbyl linker group and the reversible functionalized olefin copolymer can be obtained from the above compound of Formula (V) wherein X is a monovalent hydrocarbon groups.

The Diels-Alder reaction can be carried out in any suitable vessel. In one embodiment, the Diels-Alder reaction is carried out in a tube reactor. In another embodiment, the Diels-Alder reaction is carried out in a standard pressure vessel.

In certain embodiments, the Diels-Alder reaction is carried out at a temperature from about 50° C. to about 200° C. For example, the Diels-Alder reaction can be carried out at a temperature from about 60° C. to about 160° C., or from about 70° C. to about 120° C., or from about 75° C. to about 100° C.

The Diels-Alder reaction can be carried out in any compatible aqueous or organic solvent. In one embodiment, a polar organic solvent is used. Suitable organic solvents include, but are not limited to, benzene, toluene, dioxane, xylene, nitrobenzene, acetone, chlorobenzene, ethyl ether, cyclohexane, hexane, chloroform, dichloromethane, tetrahydrofuran, ethyl acetate, dimethylformamide, acetonitrile, dimethyl sulfoxide, formic acid, butanol, isopropanol, propanol, ethanol, methanol or combinations thereof.

The course and completion of the Diels-Alder reaction can be monitored by any method known to those skilled in the art. Suitable methods for monitoring the Diels-Alder reaction include thin layer chromatography, gas chromatography, high performance liquid chromatography, mass spectroscopy and nuclear magnetic resonance spectroscopy.

One of skill in the art will recognize that the run time for the Diels-Alder reaction described herein will vary based on the reactants, reactant concentration, solvent and temperature. Accordingly, the run time for the Diels-Alder reaction described herein can be in the range from 1 hour to 72 hours, preferably from 3 hours to 50 hours, more preferably from 8 hours to 40 hours, most preferably from 16 hours to 32 hours. The reaction can either be run until all of the reactants have been consumed or can be halted prematurely to allow for isolation of the product.

The reversible crosslinked or functionalized olefin copolymers can be purified by any method known to one of skill in the art, including, but not limited to, filtration, extraction, chromatography, crystallization or membrane separation.

The reversible crosslinked or functionalized olefin copolymers can be further processed by the following process: reaction injection molding, compression molding, pultrusion, or resin transfer molding etc. to obtain the crosslinked materials.

Depending on the applications, various additives, which include but are not limited to impact modifiers, antioxidants, reinforcing materials, density modifiers, flame retardants, fillers etc., can be added to the reversible crosslinked or functionalized olefin copolymers during the process.

Suitable impact modifiers include, but are not limited to, natural rubber, butyl rubber, polyisoprene, polybutadiene, polyisobutylene, ethylene-propylene copolymer, styrene-butadiene-styrene triblock rubber, random styrene-butadiene rubber, styrene-isoprene-styrene triblock rubbers, styrene-ethylene/butylene-styrene copolymers, styrene-ethylene/propylene-styrene copolymers, ethylene-propylene-diene terpolymers, ethylene-vinyl acetate, and nitrile rubbers.

Suitable antioxidants include, but are not limited to, 2,6-di-tert-butyl-4-methylphenol (BHT); 2- and 3-tert-butyl-4-methoxyphenol; alkylated hindered phenols; 4-hydroxymethyl-2,6-di-tert-butylphenol; 2,6-di-tert-butyl-4-sec-butylphenol; 2,2′-methylenebis(4-methyl-6-tert-butylphenol); 2,2′-methylenebis(4-ethyl-6-tert-butylphenol); 4,4′-methylenebis(2,6-di-tert-butylphenol); 2,2′-methylenebis(4-methyl-6-(1-methylcyclohexyl)phenol); 4,4′-butylidenebis(6-tert-butyl-3-methylphenol); polybutylated bisphenol A; 4,4′-thiobis(6-tert-butyl-3-methylphenol); 4,4′-methylenebis(2,6-dimethylphenol); 1,1′-thiobis(2-naphthol); 2,2′-thiobis(4-methyl-6-tert-butylphenol); 4,4′-methylenebis(2,6-di-tertiary butylphenol); 1,3,5-tris(3,5-di-tert-butyl-4-hydroxybenzyl)isocyanurate; 2,5-di-tert-amylhydroquinone, tert-butylhydroquinone, tris(nonylphenyl)phosphite, bis(2,4-di-tert-butyl)pentacrythritol) diphosphite, distearyl pentaerythritol diphosphite; 1,6-hexamethylenebis(3-(3,5-di-tert-butyl-4-hydroxyphenylpropionate) and octadecyl-3,5-di-tert-. butyl-4-hydroxyhydrocinnamate, tetrakis(2,4-di-tert-butylphenyl)4,4′-biphenylenediphosphonite, diphenylamine, and 4,4′-dimethoxydiphenylamine.

Suitable reinforcing materials include those that, when incorporated into the thermoset materials, add strength or stiffness to the thermoset materials. The reinforcing material can be in the form of filaments, fibers, rovings, mats, textiles, knit materials, fabrics or other known structures. Suitable reinforcing materials include glass fibers and fabrics, carbon fibers and fabrics, aramid fibers and fabrics, polyolefin fibers and fabrics.

Suitable density modifiers include, but are not limited to, glass, metals, thermoplastics or thermoset and/or ceramic/silicate microspheres; glass, plastic or ceramic beads; metal rods, chunks or pieces; hollow glass, ceramic, plastic or metal spheres or tubes, and the like.

Suitable flame retardants include, but are not limited to various chlorine and bromine flame retardants, preferred are as follows: hexabromobenzene, pentabromoethylbenzene, hexabromobiphenyl, decabromodiphenyl, hexabromodiphenyl oxide, octabromodiphenyl oxide, decabromodiphenyl oxide, pentabromocyclohexane, tetrabromobisphenol A and derivatives thereof, for example, tetrabromobisphenol A-bis(hydroxyethyl ether), tetrabromobisphenol A-bis(2,3-dibromopropyl ether), tetrabromobisphenol A-bis(bromoethyl ether), and tetrabromobisphenol A-bis(allyl ether)], tetrabromobisphenol S and derivatives thereof [for example, tetrabromobisphenol S-bis(hydroxyethyl ether) and tetrabromobisphenol S-bis(2,3-dibromopropyl ether)], tetrabromophthalic anhydride and derivatives thereof (for example, tetrabromo-phthalimide and ethylenebistetrabromophthalimide), ethylenebis(5,6-dibromonorbornene-2,3-dicarboxyimide), tris-(2,3-dibromopropyl)-isocyanurate, Diels-Alder reaction adducts of hexachlorocyclopentadiene, tribromophenylglycidyl ether, tribromophenyl acrylate, ethylene-bistribromophenyl ether, ethylenebispentabromophenyl ether, tetradecabromodiphenoxybenzene, brominated polystyene, brominated polyphenylene oxide, brominated epoxy resin, brominated polycarbonate, polypentabromobenzyl acrylate, octabromonaphthalene, hexabromocyclododecane, bis(tribromophenyl)-fumaramide, and N-methylhexabromodiphenylamine.

Suitable fillers include, but are not limited to, finely divided inorganic solid materials such as silica, fumed silica, diatomaceous earth, calcium carbonate, calcium silicate, aluminum silicate, kaolin, talc, bentonite, clay and carbon black.

Such additives can be used in effective amounts, which vary depending upon the property required. Depending on the type of additives, they can be added in an amount of 0.001 wt % to 80 wt %, based on the weight of the reversible crosslinked or functionalized olefin copolymers.

In one embodiment, the reversible crosslinked or functionalized olefin copolymers can be further processed under the conventional conditions, for example at a temperature from 100° C. to 300° C., preferably from 110° C. to 250° C., more preferably from 120° C. to 180° C., most preferably from 130° C. to 150° C.

The tensile modulus of the crosslinked materials can be from 0.2 to 800 MPa, such as 0.4 MPa, 1 MPa, 5 MPa, 10 MPa, 20 MPa, 50 MPa, 100 MPa, 200 MPa, 300 MPa, 400 MPa, 500 MPa, 600 MPa, 700 MPa, 800 MPa, or any value between these values, as measured by a tensile machine, for example INSTRON 5966 Universal Testing Systems or Zwick/Roell Universal testing machines, at 25° C. under a tensile rate of 5 mm/min.

The tensile modulus (Chord 0.25%) of the crosslinked materials can be from 2 MPa to 800 MPa, such as 3 MPa, 5 MPa, 10 MPa, 20 MPa, 50 MPa, 80 MPa, 100 MPa, 150 MPa, 180 MPa, 300 MPa, 400 MPa, 500 MPa, 600 MPa, 700 MPa, 800 MPa, or any value between these values, as measured by a tensile machine, for example INSTRON 5966 Universal Testing Systems or Zwick/Roell Universal testing machines, at 25° C. under a tensile rate of 5 mm/min.

The tensile stress at break of the crosslinked materials can be from 0.2 MPa to 80 MPa, such as 0.4 MPa, 1 MPa, 5 MPa, 10 MPa, 20 MPa, 50 MPa, 60 MPa, 70 MPa, or any value between these values, as measured by a tensile machine, for example INSTRON 5966 Universal Testing Systems or Zwick/Roell Universal testing machines, at 25° C. under a tensile rate of 5 mm/min.

The tensile strain at break of the crosslinked materials can be from 2% to 200%, such as 4%, 10%, 25%, 50%, 80%, 100%, 120%, 150%, 160%, 180%, 190%, or any value between these values, as measured by a tensile machine, for example INSTRON 5966 Universal Testing Systems or Zwick/Roell Universal testing machines, at 25° C. under a tensile rate of 5 mm/min.

The reversible crosslinked or functionalized olefin copolymer as described herein performs as a thermoset material in use while still demonstrates the processability like traditional thermoplastics. The de-crosslinking process is triggered at higher temperature, which enables the material with good processability. While cooling down, crosslink would be further reformed and provides higher strength, better elasticity, resilience etc.

The various descriptive elements and numerical ranges disclosed herein for the furan moiety-containing olefin copolymer or composition thereof described herein can be combined with other descriptive elements and numerical ranges to describe the invention(s); further, for a given element, any upper numerical limit can be combined with any lower numerical limit described herein, including the examples. The features of the invention are demonstrated in the following non-limiting examples.

### EXAMPLES

The present invention is now further illustrated by reference to the following examples, however, the examples are used for the purpose of explanation and not intended to limit the scopes of the invention.

### Materials and Characterizations

### Materials

Toluene, purity of 99.9%, was purchased from Jiangsu Yonghua Fine Chemical Co., Ltd., and distilled under N₂ over sodium-benzophenone prior to use.

1-hexene, purity of 97%, was purchased from J&K scientific, and dried and stored over 4 Å molecule sieves under N₂.

8-(2-furyl)-1-octene, purity of 95%, purchased from Shanghai Medicilon Inc.

Ethylene, polymerization grade, was purchased from Hangzhou Minxing Chemical Technology Co., Ltd, and deoxidized and dried prior to use.

Norbornene, purity of 99%, was purchased from J&K scientific.

1,1′-(methylenedi-4,1-phenylene) bismaleimide, purity of 95%, available from Sigma aldrich.

Methylaluminoxane (MAO), 10 wt % in toluene, purchased from Beijing Huawei Ruike Chemical Co., Ltd.

Complex rac-[En(Ind)₂]ZrCl₂ was purchased from Sinocompound Catalysts Co., Ltd., and used without further purification.

Complex [Me₂Si(C₅Me₄)(N′Bu)]TiCl₂ was purchased from Sinocompound Catalysts Co., Ltd., and used without further purification.

Complex [Ph₂C(Flu)(Cp)]ZrCl₂ was purchased from Sinocompound Catalysts Co., Ltd., and used without further purification.

### Characterizations

The molar content of unit derived from each component is determined by ¹H NMR analysis of the polymer sample at 700 MHz by using a NMR spectrometer from Bruker.

The weight average molecular weight of the polymers is determined by Gel Permeation Chromatography (GPC), by using GPC-IR from Polymer Char.

The glass transition temperature of the polymers is determined by Differential Scanning Calorimetry (DSC) with a temperature ramp of 10° C./min from −100° C. to 250° C., or by Dynamic Mechanical Thermal Analysis (DMTA) in torsion fixture at a frequency of 1 Hz in the temperature range from 35° C. to 350° C. with a heating rate of 5° C./min in N₂ atmosphere.

To test the tensile and flexural behaviors of the polymers, the material was molded by hot press at 200° C., 0.5 MPa for 5 minutes to obtain the testing bar (according to ISO 37:2017, Type 2/Type 3 specimen), the stress-strain curve of the testing bar was characterized by a tensile machine (for example INSTRON 5966 Universal Testing Systems) at 25° C. under a tensile rate of 5 mm/min. The result is reported as average value of five measurement.

### Example 1: Synthesis of E-H-F Terpolymer with 3.2 mol % of Furan Moiety

At room temperature, 150 ml of toluene, 8.25 ml of 1-hexene and 1.06 g of 8-(2-furyl)-1-octene were charged into a 0.3 L of Buchi reactor purged with ethylene, followed by 7.2 mL 10 wt % methylaluminoxane (MAO) in toluene solution (Al/Zr molar ratio=˜2000). The reactor was pressurized to a pressure of 0.25 MPa and kept at this pressure by continuous ethylene supply, and raised to a temperature of 60° C. and kept at this temperature. Then, 2.6 mg of precatalyst rac-[En(Ind)₂]ZrCl₂ dissolved in 2 ml of toluene was transferred into the reactor with slightly higher pressure in single pulse to initiate the polymerization.

After the polymerization time reached 30 minutes at a pressure of 0.25 MPa and a temperature of 60° C., the polymerization solution was precipitated with methanol and washed with methanol. The resulting polymer I was dried under vacuum and weighed as 2.12 g.

For characterization of polymer 1, Gel Permeation Chromatography, Differential Scanning Calorimetry and ¹H NMR spectroscopy were employed.

In the resulting polymer 1, the molar content of unit derived from 1-hexene is 20.6%, the molar content of unit derived from 8-(2-furyl)-1-octene is 3.2%, and the molar content of unit derived from ethylene is 76.2%, as determined by ¹H NMR. The weight average molecular weight of the polymer 1 is 222.1 KDa, PDI=4.54, as determined by GPC.

### Example 2: Synthesis of E-H-F Terpolymer with 7.7 mol % of Furan Moiety

At room temperature, 100 ml of toluene, 3.7 ml of 1-hexene and 2.2 g of 8-(2-furyl)-1-octene were charged into a 250 ml of glass reactor purged with ethylene, followed by 9.3 mL 10 wt % MAO in toluene solution (Al/Zr molar ratio=˜2000). The reactor was kept to a pressure of 0.1 MPa by continuous ethylene supply, and raised to a temperature of 30° C. and kept at this temperature. Then, 3.35 mg of precatalyst rac-[En(Ind)₂]ZrCl₂ dissolved in 2 ml of toluene was transferred into the reactor with slightly higher pressure in single pulse to initiate the polymerization.

After the polymerization time reached 20 minutes at a pressure of 0.1 MPa and a temperature of 30° C., the polymerization solution was precipitated with methanol and washed with methanol. The resulting polymer 2 was dried under vacuum.

For characterization of polymer 2, Gel Permeation Chromatography, Differential Scanning Calorimetry, DMTA and ¹H NMR spectroscopy were employed.

In the resulting polymer 2, the molar content of unit derived from 1-hexene is 24.3%, the molar content of unit derived from 8-(2-furyl)-1-octene is 7.7%, and the molar content of unit derived from ethylene is 68.0%, as determined by ¹H NMR. The weight average molecular weight of the polymer 2 is 43.2 KDa, PDI=3.29, as determined by GPC. The glass transition temperature of the polymer 2 is −55.69° C., as determined by DMTA.

### Example 3: Synthesis of E-H-F Terpolymer with 5 mol % of Furan Moiety

At room temperature, 100 ml of toluene, 5 ml of 1-hexene and 1.3 g of 8-(2-furyl)-1-octene were charged into a 250 ml of glass reactor purged with ethylene, followed by 9.3 mL 10 wt % of MAO in toluene solution (Al/Zr molar ratio=˜2000). The reactor was pressurized to a pressure of 0.1 MPa and kept at this pressure by continuous ethylene supply, and raised to a temperature of 30° C. and kept at this temperature. Then, 3.35 mg of precatalyst rac-[En(Ind)₂]ZrCl₂ dissolved in 2 ml of toluene was transferred into the reactor with slightly higher pressure in single pulse to initiate the polymerization.

After the polymerization time reached 20 minutes at a pressure of 0.1 MPa and a temperature of 30° C., the polymerization solution was precipitated with methanol and washed with methanol. The resulting polymer 3 was dried under vacuum. For characterization of polymer 3, Gel Permeation Chromatography, Differential Scanning Calorimetry, DMTA and ¹H NMR spectroscopy were employed.

In the resulting polymer 3, the molar content of unit derived from 1-hexene is 33.1%, the molar content of unit derived from 8-(2-furyl)-1-octene is 5.0%, and the molar content of unit derived from ethylene is 61.9%, as determined by ¹H NMR. The weight average molecular weight of the polymer 3 is 29.2 KDa, PDI=2.64, as determined by GPC. The glass transition temperature of the polymer 3 is −53.67° C., as determined by DMTA.

### Example 4: Synthesis of E-H-F Terpolymer with 7.8 mol % of Furan Moiety

At room temperature, 100 ml of toluene, 5 ml of 1-hexene and 2.9 g of 8-(2-furyl)-1-octene were charged into a 250 ml of glass reactor purged with ethylene, followed by 9.3 mL 10 wt % of MAO in toluene solution (Al/Zr molar ratio=˜2000). The reactor was pressurized to a pressure of 0.1 MPa and kept at this pressure by continuous ethylene supply, and raised to a temperature of 30° C. and kept at this temperature. Then, 3.35 mg of precatalyst rac-[En(Ind)₂]ZrCl₂ dissolved in 2 ml of toluene was transferred into the reactor with slightly higher pressure in single pulse to initiate the polymerization.

After the polymerization time reached 40 minutes at a pressure of 0.1 MPa and a temperature of 30° C., the polymerization solution was precipitated with methanol and washed with methanol. The resulting polymer 4 was dried under vacuum. For characterization of polymer 4, Gel Permeation Chromatography, Differential Scanning Calorimetry, DMTA and ¹H NMR spectroscopy were employed.

In the resulting polymer 4, the molar content of unit derived from 1-hexene is 21.8%, the molar content of unit derived from 8-(2-furyl)-1-octene is 7.8%, and the molar content of unit derived from ethylene is 70.4%, as determined by ¹H NMR. The weight average molecular weight of the polymer 4 is 50.8 KDa, PDI=3.41, as determined by GPC. The glass transition temperature of the polymer 4 is −56° C., as determined by DMTA.

### Example 5: Synthesis of E-H-F Terpolymer with 17.3 mol % of Furan Moiety

At room temperature, 50 ml of toluene, 2.5 ml of 1-hexene and 4.1 g of 8-(2-furyl)-1-octene were charged into a 100 ml of glass reactor purged with ethylene, followed by 4.7 mL 10 wt % of MAO in toluene solution (Al/Zr molar ratio=˜2000). The reactor was pressurized to a pressure of 0.1 MPa and kept at this pressure by continuous ethylene supply, and raised to a temperature of 30° C. and kept at this temperature. Then, 1.68 mg of precatalyst rac-[En(Ind)₂]ZrCl₂ dissolved in 2 ml of toluene was transferred into the reactor with slightly higher pressure in single pulse to initiate the polymerization.

After the polymerization time reached 40 minutes at a pressure of 0.1 MPa and a temperature of 30° C., the polymerization solution was precipitated with methanol and washed with methanol. The resulting polymer 5 was dried under vacuum. For characterization of polymer 5, Gel Permeation Chromatography, Differential Scanning Calorimetry, DMTA and ¹H NMR spectroscopy were employed.

In the resulting polymer 5, the molar content of unit derived from 1-hexene is 20.8%, the molar content of unit derived from 8-(2-furyl)-1-octene is 17.3%, and the molar content of unit derived from ethylene is 61.9%, as determined by ¹H NMR. The weight average molecular weight of the polymer 5 is 81.5 KDa, PDI=4.77, as determined by GPC. The glass transition temperature of the polymer 5 is −56.41° C., as determined by DMTA.

### Example 6: Synthesis of E-H-F Terpolymer with 0.84 mol % of Furan Moiety

At room temperature, 100 ml of toluene, 2.5 ml of 1-hexene and 0.7 g of 8-(2-furyl)-1-octene were charged into a 250 ml of glass reactor purged with ethylene, followed by 18.6 mL 10 wt % of MAO in toluene solution (Al/Ti molar ratio=˜4000). The reactor was pressurized to a pressure of 1.0 MPa and kept at this pressure by continuous ethylene supply, and raised to a temperature of 30° C. and kept at this temperature. Then, 2.95 mg of precatalyst [Me₂Si(C₅Me₄)(N^{t}Bu)]TiCl₂ dissolved in 2 ml of toluene was transferred into the reactor with slightly higher pressure in single pulse to initiate the polymerization.

After the polymerization time reached 20 minutes at a pressure of 0.1 MPa and a temperature of 30° C., the polymerization solution was precipitated with methanol and washed with methanol. The resulting polymer 6 was dried under vacuum and weighed as 7.95 g. For characterization of polymer 6, Gel Permeation Chromatography, Differential Scanning Calorimetry, DMTA and ¹H NMR spectroscopy were employed.

In the resulting polymer 6, the molar content of unit derived from 1-hexene is 7.1%, the molar content of unit derived from 8-(2-furyl)-1-octene is 0.8%, and the molar content of unit derived from ethylene is 92.1%, as determined by ¹H NMR. The weight average molecular weight of the polymer 6 is 235 KDa, PDI=5.96, as determined by GPC. The glass transition temperature of the polymer 6 is −46.96° C., as determined by DSC.

### Example 7: Synthesis of E-H-F Terpolymer with 1.3 mol % of Furan Moiety

At room temperature, 100 ml of toluene, 2.5 ml of 1-hexene and 0.7 g of 8-(2-furyl)-1-octene were charged into a 250 ml of glass reactor purged with ethylene, followed by 18.6 mL 10 wt % of MAO in toluene solution (Al/Ti molar ratio=˜4000). The reactor was pressurized to a pressure of 1.0 MPa and kept at this pressure by continuous ethylene supply and raised to a temperature of 90° C. and kept at this temperature. Then, 2.95 mg of precatalyst [Me₂Si(C₅Me₄)(N^{t}Bu)]TiCl₂ dissolved in 2 ml of toluene was transferred into the reactor with slightly higher pressure in single pulse to initiate the polymerization.

After the polymerization time reached 20 minutes at a pressure of 1.0 MPa and a temperature of 90° C., the polymerization solution was precipitated with methanol and washed with methanol. The resulting polymer 7 was dried under vacuum and weighed as 18.26 g. For characterization of polymer 7, Gel Permeation Chromatography, Differential Scanning Calorimetry, DMTA and ¹H NMR spectroscopy were employed.

In the resulting polymer 7, the molar content of unit derived from 1-hexene is 7.9%, the molar content of unit derived from 8-(2-furyl)-1-octene is 1.3%, and the molar content of unit derived from ethylene is 90.8%, as determined by ¹H NMR. The weight average molecular weight of the polymer 7 is 47 KDa, PDI=3.31, as determined by GPC.

### Example 8: Synthesis of E-NB-F Terpolymer with 0.87 mol % of Furan Moiety

At room temperature, 150 ml of toluene, 5.6 g of norbornene, 1.06 g of 8-(2-furyl)-1-octene were charged into a 0.3 L of Buchi reactor purged with ethylene, followed by 5.2 mL 10 wt % of MAO in toluene solution (Al/Zr molar ratio=˜2000). The reactor was pressurized to a pressure of 0.3 MPa, and the system pressure was kept by continuous ethylene supply, and raised to a temperature of 60° C. and kept at this temperature. Then, 2.5 mg of the precatalyst [Ph₂C(Flu)(Cp)]ZrCl₂ dissolved in 2 ml of toluene was transferred into the reactor with slightly higher pressure in single pulse to initiate the polymerization.

After the polymerization time reached 30 minutes at a pressure of 0.3 MPa and a temperature of 60° C., the polymerization solution was precipitated with methanol and washed with methanol. The resulting polymer 8 was dried in vacuum and weighed as 4.74 g. For characterization of polymer 8, Gel Permeation Chromatography, Differential Scanning Calorimetry and ¹H NMR spectroscopy were employed.

In the resulting polymer 8, the molar content of unit derived from norbornene is 19.9%, the molar content of unit derived from 8-(2-furyl)-1-octene is 0.9%, and the molar content of unit derived from ethylene is 79.2%, as determined by ¹H NMR. The weight average molecular weight of the polymer 8 is 196.6 KDa, PDI=2.66, as determined by GPC. The glass transition temperature of the polymer 8 is 46.96° C., as determined by DSC.

### Example 9: Synthesis of E-NB-F Terpolymer with 3.7 mol % of Furan Moiety

At room temperature, 50 ml of toluene, 2.01 g of norbornene, 1.43 g of 8-(2-furyl)-1-octene were charged into a 100 ml of glass reactor purged with ethylene, followed by 4.7 mL 10 wt % of MAO in toluene solution (Al/Zr molar ratio=˜2000). The reactor was pressurized to a pressure of 0.1 MPa, and the system pressure was kept by continuous ethylene supply and raised to a temperature of 30° C. and kept at this temperature. Then, 1.68 mg of precatalyst rac-[En(Ind)₂]ZrCl₂ dissolved in 2 ml of toluene was transferred into the reactor with slightly higher pressure in single pulse to initiate the polymerization.

After the polymerization time reached 30 minutes at a pressure of 0.1 MPa and a temperature of 30° C., the polymerization solution was precipitated with methanol and washed with methanol. The resulting polymer 9 was dried in vacuum. For characterization of polymer 9, Gel Permeation Chromatography, Differential Scanning Calorimetry and ¹H NMR spectroscopy were employed.

In the resulting polymer 9, the molar content of unit derived from norbornene is 73.1%, the molar content of unit derived from 8-(2-furyl)-1-octene is 3.7%, and the molar content of unit derived from ethylene is 23.2%, as determined by ¹H NMR. The weight average molecular weight of the polymer 9 is 6.4 KDa, PDI=2.05, as determined by GPC. The glass transition temperature of the polymer 9 is 38.97° C., as determined by DSC.

### Example 10: Synthesis of E-NB-F Terpolymer with 5 mol % of Furan Moiety

At room temperature, 50 ml of toluene, 4.03 g of norbornene, 2.38 g of 8-(2-furyl)-1-octene were charged into a 100 ml of glass reactor purged with ethylene, followed by 4.7 mL 10 wt % of MAO in toluene solution (Al/Zr molar ratio=˜2000). The reactor was pressurized to a pressure of 0.1 MPa and kept at this pressure by continuous ethylene supply and raised to a temperature of 30° C. and kept at this temperature. Then, 1.68 mg of precatalyst rac-[En(Ind)₂]ZrCl₂ dissolved in 2 ml of toluene was transferred into the reactor with slightly higher pressure in single pulse to initiate the polymerization.

After the polymerization time reached 30 minutes at a pressure of 0.1 MPa and a temperature of 30° C., the polymerization solution was precipitated with methanol and washed with methanol. The resulting polymer 10 was dried in vacuum. For characterization of polymer 10, Gel Permeation Chromatography, Differential Scanning Calorimetry and ¹H NMR spectroscopy were employed.

In the resulting polymer 10, the molar content of unit derived from norbornene is 68.3%, the molar content of unit derived from 8-(2-furyl)-1-octene is 5.0%, and the molar content of unit derived from ethylene is 26.7%, as determined by ¹H NMR. The weight average molecular weight of the polymer 10 is 6.5 KDa, PDI=2.03, as determined by GPC.

### Example 11: Reversible Crosslink of Polymer 2

At room temperature, 2.16 g of polymer 2 was dissolved in a mixture of 80 ml of THF and 20 ml of toluene, then 0.35 g of 1,1′-(methylenedi-4,1-phenylene) bismaleimide was added. The polymer solution was gradually heated to 80° C. and stirred overnight. The resulting suspension was precipitated with methanol, filtered and washed with methanol and finally dried under vacuum at 80° C. for 24 hours.

The specimens for tensile testing and regular rheological measurements were prepared by hot press molding at 130° C. under 10 MPa for 5 minutes, and annealing at 80° C. for 10 minutes. The properties of crosslinked polymer 2 are showed in Table 1.

### Example 12: Reversible Crosslink of Polymer 3

At room temperature, 2.7 g of polymer 3 was dissolved in a mixture of 80 ml of THF and 20 ml of toluene, then 0.7 g of 1,1′-(methylenedi-4,1-phenylene) bismaleimide was added. The polymer solution was gradually heated to 80° C., and stirred overnight. The resulting suspension was precipitated with methanol, filtered and washed with methanol and finally dried under vacuum at 80° C. for 24 hours.

The specimens for tensile testing and regular rheological measurements were prepared by compression molding at 130° C. under 10 MPa for 5 minutes, and annealing at 80° C. for 10 minutes. The properties of crosslinked polymer 3 are showed in Table 1.

### Example 13: Reversible Crosslink of Polymer 4

At room temperature, 4.53 g of polymer 4 was dissolved in 100 ml of THF, then 1.22 g of 1,1′-(Methylenedi-4,1-phenylene) bismaleimide was added. The polymer solution was gradually heated to 80° C. and stirred overnight. The resulting suspension was precipitated with methanol, filtered and washed with methanol and finally dried under vacuum at 80° C. for 24 hours.

1. A furan moiety-containing olefin copolymer comprising or consisting of the following monomers in copolymerized form:
A1) ethylene;
A2) a comonomer, which is selected from the group consisting of a functional α-olefin of Formula (I), a functional cyclic olefin of Formula (II) having a furan functional group, or a combination thereof, 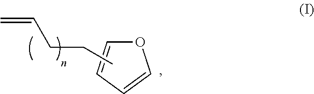
wherein the furyl ring in Formula (I) is optionally substituted with a halogen atom, or C₁-C₂₀ hydrocarbon group;
n is an integer in the range from 0 to 12; 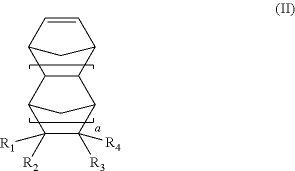
wherein R₁, R₂, R₃ and R₄ independently from each other represent a functional group containing furan moiety, a hydrogen atom, a halogen atom, or C₁-C₂₀ hydrocarbon group, wherein at least one of R₁ and R₂ represents a functional group containing furan moiety; or
two of R₁, R₂, R₃ and R₄ are bonded together to form a 3- to 7-membered saturated, or partially unsaturated or aromatic carbo-or heterocyclic ring containing at least one furan moiety, which may contain 1 to 4 heteroatoms selected from N, O and S;
a is an integer in the range from 0 to 5;
and optionally
A3) a comonomer, which is selected from the group consisting of C₄-C₂₀ α-olefin, a cyclic olefin and acyclic C₄-C₃₀ diolefin.

2. The furan moiety-containing olefin copolymer according to claim 1, wherein in Formula (I), n is an integer in the range from 1 to 11.

3. The furan moiety-containing olefin copolymer according to claim 1, wherein the functional α-olefin of Formula (I) includes 2-furyl or 3-furyl.

4. The furan moiety-containing olefin copolymer according to claim 1, wherein in Formula (II), the functional group containing furan moiety represents a functional group R₅-Q, wherein R₅ represents a direct bond, divalent C₁-C₂₀ hydrocarbon group, or divalent C₂-C₂₀ hydrocarbon group interrupted by O, N, S, P, COO or CONH, and Q represents 2-furyl or 3-furyl.

5. The furan moiety-containing olefin copolymer according to claim 1, wherein in Formula (II), a is an integer in the range from 0 to 4.

6. The furan moiety-containing olefin copolymer according to claim 1, wherein as the comonomer A3), C₄-C₂₀ α-olefins include 1-butene, 1-pentene, 1-hexene, 4-methyl-1-pentene, 1-heptene, 1-octene, 1-decene, 1-dodecene, 1-tetradecene, 1-hexadecane and 1-eicosene.

7. The furan moiety-containing olefin copolymer according to claim 1, wherein as the comonomer A3), the cyclic olefins include aromatic group-containing monomers with up to 30 carbon atoms and non-aromatic cyclic group containing monomers with up to 30 carbon atoms.

8. The furan moiety-containing olefin copolymer according to claim 7, wherein the non-aromatic cyclic group containing monomers include compounds of Formula (III): 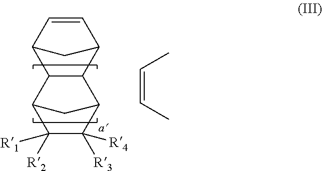
wherein R′₁, R′₂, R′₃ and R′₄ independently fro other represent a hydrogen atom, a halogen atom, or C₁-C₂₀ hydrocarbon group; or
two of R′₁, R′₂, R′₃ and R′₄ are bonded together to form a 3- to 7-membered saturated, or partially unsaturated or aromatic carbo- or heterocyclic ring, which may contain 1 to 4 heteroatoms selected from N, O and S;
a′ is an integer in the range from 0 to 5.

9. The furan moiety-containing olefin copolymer according to claim 8, wherein a′ is an integer in the range from 0 to 4.

10. The furan moiety-containing olefin copolymer according to claim 1, wherein as the comonomer A3), acyclic C₄-C₃₀ diolefin monomers include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene.

11. The furan moiety-containing olefin copolymer according to claim 1, wherein the amount of unit derived from ethylene is in the range from 10 to 99.9 mol %, based on the total molar amount of the monomeric units in the furan moiety-containing olefin copolymer.

12. The furan moiety-containing olefin copolymer according to claim 1, wherein the amount of unit derived from the comonomer A2) is in the range from 0.01 to 30 mol %, based on the total molar amount of the monomeric units in the furan moiety-containing olefin copolymer.

13. The furan moiety-containing olefin copolymer according to claim 1, wherein the amount of unit derived from the comonomer A3) is in the range from 0 to 85 mol %, based on the total molar amount of the monomeric units in the furan moiety-containing olefin copolymer.

14. The furan moiety-containing olefin copolymer according to claim 1, wherein the weight-average molecular weight (M_{w}) of the furan moiety-containing olefin copolymer is in the range from 4 to 300 KDa.

15. The furan moiety-containing olefin copolymer according to claim 1, wherein the polydispersity index (PDI) (M_{w}/Mₙ) of the furan moiety-containing olefin copolymer is in the range from 1.2 to 8.

16. A process for preparing the furan moiety-containing olefin copolymer according to claim 1 by copolymerizing monomers A1), A2) and optionally A3).

17. The process according to claim 16, wherein said process is carried out with a precatalyst compound, which is represented by the Formula (IV): 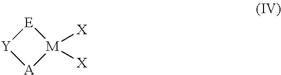
wherein;
M is a Group IIIB, IVB, VB, VIB or VIII transition metal atom, a Lanthanide metal atom, or an Actinide metal atom;
E is substituted or unsubstituted cyclopentadienyl ligand, substituted or unsubstituted indenyl ligand, or substituted or unsubstituted fluorenyl ligand;
A is substituted or unsubstituted indenyl ligand, a substituted or unsubstituted cyclopentadienyl ligand, a substituted or unsubstituted fluorenyl ligand or —NR, wherein R represent a hydrogen atom, a halogen atom, or C₁-C₂₀ hydrocarbon group;
Y is a bridging group comprising C, Si or Ge, wherein these bridging groups are unsubstituted or substituted with at least one substituents selected from the group consisting of halogen, C₁-C₆ alkyl group or phenyl, preferably C₁-C₄ alkyl group or phenyl, more preferably methyl or phenyl; and
each X is, independently, a univalent anionic ligand, or both X are joined and bound to the metal atom to form a metallocycle ring, or both X are joined to form a chelating ligand, a diene ligand, or an alkylidene ligand.

18. Use of the furan moiety-containing olefin copolymer according to claim 1 as or in polymer compatibilizer, adhesive, barrier, composite, packaging, sealing, automobile or construction blocks.

19. A reversible crosslinked or functionalized olefin copolymer prepared via Diels-Alder reaction of the furan moiety-containing olefin copolymer according to claim 1 and organic connecting reagent.

20. The reversible crosslinked or functionalized olefin copolymer according to claim 19, wherein the organic connecting reagent is a compound of Formula (V): 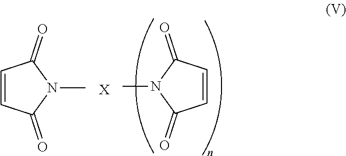
wherein X is a monovalent hydrocarbon group or multivalent hydrocarbyl linker group, and n is 0 or an integer of at least 1.
